(19) United States
(12) Patent Application Publication
(10) Pub. No.: US 2024/0098533 A1
(43) Pub. Date: Mar. 21, 2024

(54) AI/ML MODEL MONITORING OPERATIONS FOR NR AIR INTERFACE

(71) Applicant: Samsung Electronics Co., Ltd., Suwon-si (KR)

(72) Inventors: Shiyang Leng, Allen, TX (US); Jeongho Jeon, San Jose, CA (US); Kyeongin Jeong, Allen, TX (US); Caleb K. Lo, San Jose, CA (US)

(21) Appl. No.: 18/457,960

(22) Filed: Aug. 29, 2023

Related U.S. Application Data
(60) Provisional application No. 63/407,002, filed on Sep. 15, 2022.
(60) Provisional application No. 63/409,452, filed on Sep. 23, 2022.

(51) Int. Cl. H04W 24/08; H04L 41/16; H04W 24/02

(52) U.S. Cl. CPC H04W 24/08; H04L 41/16; H04W 24/02

(57) ABSTRACT

An AI/ML monitoring operation is based on a received monitoring configuration forming part of a configuration for using an AI/ML model for a communications system operation. Based on the monitoring configuration, AI/ML model assistance information is reported, including AI/ML model monitoring results from the AI/ML monitoring operation. AI/ML model management and adaptation information based on those AI/ML model monitoring results is received, an AI/ML model management and adaptation operation is performed. The AI/ML model management and adaptation information may include parameters that characterize an action of AI/ML model management and adaptation or an indication of an action of AI/ML model management and adaptation. The action of AI/ML model management and adaptation may comprise one of model switch, model refinement or update, or model transfer.

### CROSS-REFERENCE TO RELATED APPLICATION AND CLAIM OF PRIORITY

This application claims priority under 35 U.S.C. § 119(e) to U.S. Provisional Patent Application No. 63/407,002 filed Sep. 15, 2022, and U.S. Provisional Patent Application No. 63/409,452 filed Sep. 23, 2022. The content of the above-identified patent document(s) is incorporated herein by reference.

### TECHNICAL FIELD

The present disclosure relates generally to artificial intelligence/machine learning (AI/ML) monitoring operations and, more specifically, to AI/ML model management and adaptation operation of one or more user equipments in a wireless communication system.

### BACKGROUND

To meet the demand for wireless data traffic having increased since deployment of 4G communication systems and to enable various vertical applications, 6G/5G/NR communication systems have been developed and are currently being deployed. The 6G/5G/NR communication system is considered to be implemented in higher frequency (mmWave) bands, e.g., 28 giga-Hertz (GHz) or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 6G/5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 6G and 5G systems and frequency bands associated therewith is for reference as certain embodiments of the present disclosure may be implemented in 6G/5G systems. However, the present disclosure is not limited to 6G/5G systems or the frequency bands associated therewith, and embodiments of the present disclosure may be utilized in connection with any frequency band. For example, aspects of the present disclosure may also be applied to deployment of 6G/5G communication systems, 6G or even later releases which may use terahertz (THz) bands.

### SUMMARY

An AI/ML monitoring operation is based on a received monitoring configuration forming part of a configuration for using an AI/ML model for a communications system operation. Based on the monitoring configuration, AI/ML model assistance information is reported, including AI/ML model monitoring results from the AI/ML monitoring operation. AI/ML model management and adaptation information based on those AI/ML model monitoring results is received, an AI/ML model management and adaptation operation is performed. The AI/ML model management and adaptation information may include parameters that characterize an action of AI/ML model management and adaptation or an indication of an action of AI/ML model management and adaptation. The action of AI/ML model management and adaptation may comprise one of model switch, model refinement or update, or model transfer.

In a first embodiment, a method includes performing, at a user equipment (UE), an AI/ML monitoring operation based on a received monitoring configuration forming part of a configuration of use of an AI/ML model for an operation. The method further includes reporting, based on the monitoring configuration, AI/ML model assistance information including AI/ML model monitoring results from the AI/ML monitoring operation. The method also includes receiving, based on the AI/ML model monitoring results, AI/ML model management and adaptation information. The method still further includes performing an AI/ML model management and adaptation operation based on the AI/ML model management and adaptation information.

In a second embodiment, a UE includes a transceiver, and a processor. The processor is configured to perform an AI/ML monitoring operation based on a received monitoring configuration forming part of a configuration of use of an AI/ML model for an operation. The transceiver is configured to report, based on the monitoring configuration, AI/ML model assistance information including AI/ML model monitoring results from the AI/ML monitoring operation. The transceiver is also configured to receive, based on the AI/ML model monitoring results, AI/ML model management and adaptation information. The processor is further configured to perform an AI/ML model management and adaptation operation based on the AI/ML model management and adaptation information.

In a third embodiment, a base station includes a transceiver configured to transmit, to a UE, a monitoring configuration for monitoring an AI/ML monitoring operation. The monitoring configuration forms part of a configuration of use of an AI/ML model for an operation. The transceiver is also configured to receive, from the UE, AI/ML use assistance information including AI/ML model monitoring results from the AI/ML monitoring operation. The base station also includes a processor configured to evaluate, based on the AI/ML model monitoring results, UE-specific performance of the use of the AI/ML model for the operation. The processor is further configured to determine AI/ML model management and adaptation information corresponding to the AI/ML model monitoring results.

In any of the preceding embodiments, the AI/ML model management and adaptation information may include parameters that characterize an action of AI/ML model management and adaptation.

In any of the preceding embodiments, the AI/ML model management and adaptation information may include an indication of an action of AI/ML model management and adaptation.

In the preceding embodiment, when the indication of the action of AI/ML model management and adaptation comprises an indication of model switch, the UE may select an AU/ML model from among trained models to be applied at the UE; when the indication of the action of AI/ML model management and adaptation comprises an indication of model refinement or update, the UE may refine the AI/ML model by one or both of re-training using new training data, or re-validation using new validation data; when the indication of the action of AI/ML model management and adaptation comprises an indication of model update, the UE may one of reconstruct or prepare a new AI/ML model to be applied at the UE; and when the indication of the action of AI/ML model management and adaptation comprises an indication of model transfer, the UE may apply received AI/ML model parameters.

In any of the preceding embodiments, the monitoring configuration may include monitoring resources for monitoring in time or frequency or spatial domain, report quantities, and report types for the operation.

In the preceding embodiment, the monitoring configuration may include conditions that trigger the UE to one of report AI/ML monitoring results or autonomously perform AI/ML model management and adaptation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an exemplary networked system utilizing AI/ML empowered UE capabilities in a cellular system according to various embodiments of this disclosure;

FIG. 2 illustrates an exemplary base station (BS) utilizing AI/ML empowered UE capabilities according to various embodiments of this disclosure;

FIG. 3 illustrates an exemplary electronic device for communicating in the networked computing system utilizing AI/ML empowered UE capabilities according to various embodiments of this disclosure;

FIG. 4 illustrates a high level diagram of an overall setup for AI/ML-related UE capability transfer according to various embodiments of this disclosure;

FIG. 5 is a high level flow diagram for UE behavior in NW-centric AI/ML model monitoring within a communications system utilizing AI/ML empowered UE capabilities according to various embodiments of this disclosure;

FIG. 6 is a high level flow diagram for NW behavior in NW-centric AI/ML model monitoring within a communications system utilizing AI/ML empowered UE capabilities according to various embodiments of this disclosure;

FIG. 7 is a high level flow diagram for UE behavior in UE-centric AI/ML model monitoring within a communications system utilizing AI/ML empowered UE capabilities according to various embodiments of this disclosure; and

FIG. 8 is a high level flow diagram for NW behavior in UE-centric AI/ML model monitoring within a communications system utilizing AI/ML empowered UE capabilities according to various embodiments of this disclosure.

### DETAILED DESCRIPTION

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

### REFERENCES

[1] 3GPP RP-213599, New SI: Study on Artificial Intelligence (AI)/Machine Learning (ML) for NR Air Interface.
[2] 3GPP, TS 38.300 v17.1.0, 5G; NR; NR and NG-RAN Overall description; Stage-2.
[3] 3GPP, TS 38.331 v17.1.0, 5G; NR; Radio Resource Control (RRC); Protocol specification.
[4] 3GPP, TS 38.306 v17.1.0, 5G; NR; User Equipment (UE) radio access capabilities.
[5] 3GPP, TS 38.214 v17.2.0, 5G; NR; Physical layer procedures for data.
[6] 3GPP, TS 37.355 v17.1.0, LTE; 5G; LTE Positioning Protocol (LPP).

The above-identified reference(s) are incorporated herein by reference.

Abbreviations:

| | |
|---|---|
| AI | Artificial Intelligence |
| ML | Machine Learning |
| BS | Base Station |
| NW | Network |
| UE | User Equipment |
| NR | New Radio |
| 3GPP | 3rd Generation Partnership Project |
| CSI | Channel State Information |
| RTT | Round Trip Time |
| TDOA | Time Difference of Arrival |
| TDD | Time Division Duplex |
| FDD | Frequency Division Duplex |
| FR | Frequency Range |
| NLOS | Non-Line-of-Sight |
| FLOPS | Floating Point Operations Per Second |
| NN | Neural Network |
| CNN | Convolution Neural Network |
| RNN | Recurrent Neural Network |
| LSTM | Long Short-Term Memory |
| BiLSTM | Bidirectional Long Short-Term Memory |
| SGCS | Squared Generalized Cosine Similarity |
| GCS | Generalized Cosine Similarity |
| UMa | Urban Macrocell |
| UMi | Urban Microcell |
| InH | Indoor Hotspot |
| RMa | Rural Macrocell |
| ISD | Inter-Site Distance |
| DCI | Downlink Control Information |
| RS | Reference Signal |
| QCL | Quasi Co-located |
| SSB | Synchronization Signal Block |
| SRS | Sounding Reference Signal |
| CQI | Channel Quality Indicator |
| RI | Rank Indicator |
| RSRP | Reference Signal Received Power |
| RSRQ | Reference Signal Received Quality |
| SINR | Signal to Inference and Noise Ratio |
| CRI | CSI-RS Resource Indicator |
| SSBRI | SSB Resource Indicator |
| SLI | Strongest Layer Indicator |
| LI | Layer Indicator |
| PUCCH | Physical Uplink Control Channel |
| PUSCH | Physical Uplink Shared Channel |
| KPI | Key Performance Indicator |
| PRS | Positioning Reference Signal |

3GPP (Third-Generation Partnership Project) has developed technical specifications and standards to define the new 5^{th} Generation (5G) radio-access technology, known as 5G NR (New Radio). As the recent advances in AI/ML have brought new opportunities to wireless communications to improve performance, in release 18 a new study item [1] has been agreed to study selected use cases applying AI/ML algorithms for performance enhancements and/or complexity and overhead reduction. The initial set of use cases includes CSI feedback enhancement, e.g., overhead reduction, improved accuracy, and prediction; beam management, (such as beam prediction in time, and/or spatial domain for overhead and latency reduction, beam selection accuracy improvement; and positioning accuracy enhancements for different scenarios including, for example, those with heavy NLOS conditions).

To apply AI/ML algorithms at the UE/NW side for the selected use cases, relevant features to support the AI/ML applications are to be developed and specified per use case. The UE and the NW should communicate the UE capabilities on related AI/ML features so that the UE can be properly configured with the AI/ML operations. Correspondingly, the UE capabilities to support the related AI/ML features are desired to be specified.

The AI/ML models are expected to improve the performance for various operations and use cases, including CSI feedback enhancement, beam management, and positioning. Compared to the existing mechanisms, the AI/ML-based CSI compression is expected to provide more accurate CSI report with less overhead than the current Type-I or Type-II codebooks; the AI/ML-based beam management is expected to identify better beams for DL/UL Rx/Tx than the current beam management mechanism based on beam measurement and report or predict the next candidate beams before the current beam pairing fails; the AI/ML-based positioning is expected to provide more accurate UE location than the conventional non-AI/ML-based position methods, e.g. multi-RTT, DL-TDOA, UL-TDOA, DL-AoD, UL-AoA. However, as the application scenarios, channel models, and system parameters change, the AI/ML models may not always keep good performance so that adaptations are needed accordingly. In order to monitor the performance of AI/ML models and correspondingly adjust NW/UE behaviors, the procedure for model monitoring is desired to be designed and specified.

This disclosure specifies the UE capabilities on AI/ML related features from difference perspectives, including use cases, AI/ML model, training/inference, and model managements.

In this disclosure, the procedures of AI/ML model monitoring for various use cases are specified, including NW-centric AI/ML model monitoring procedure and UE-centric AI/ML model monitoring procedure.

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

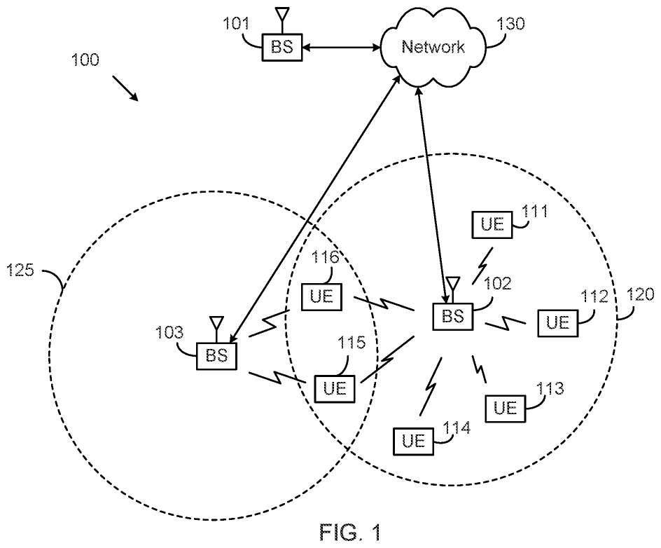

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an exemplary networked system utilizing AI/ML empowered UE capabilities in a cellular system according to various embodiments of this disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for AI/ML model management and adaptation operation of one or more of the UEs in a wireless communication system. In certain embodiments, and one or more of the gNBs 101-103 includes circuitry, programing, or a combination thereof, for supporting AI/ML model management and adaptation operation of one or more of the UEs in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

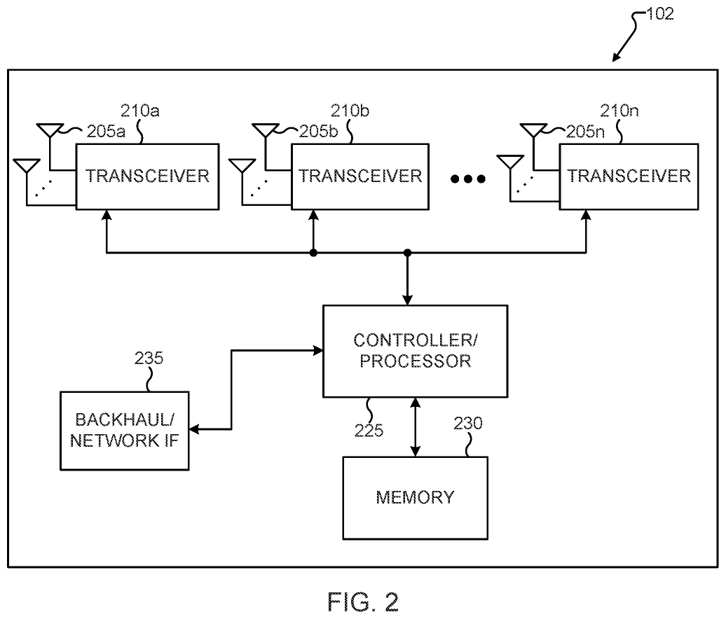

FIG. 2 illustrates an exemplary base station (BS) utilizing AI/ML empowered UE capabilities according to various embodiments of this disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting AI/ML model management and adaptation operation of one or more of the UEs in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless back-haul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

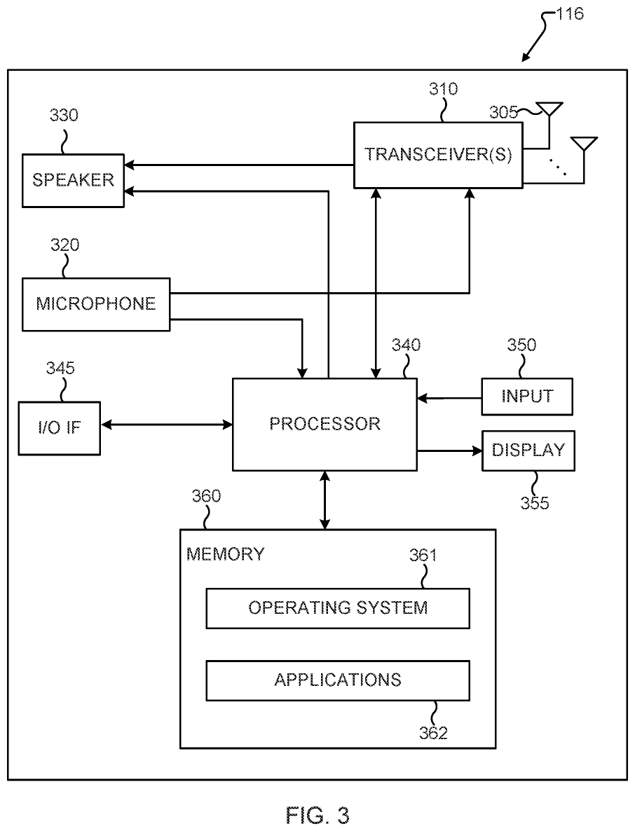

FIG. 3 illustrates an exemplary electronic device for communicating in the networked computing system utilizing AI/ML empowered UE capabilities according to various embodiments of this disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process, such as processes for AI/ML model management and adaptation operation in a wireless communication system. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

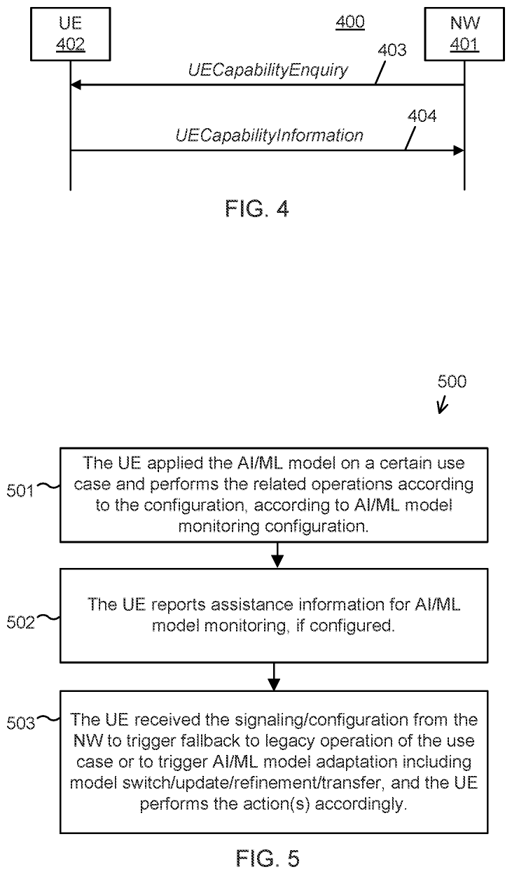

FIG. 4 illustrates a high level diagram of an overall setup for AI/ML-related UE capability transfer according to various embodiments of this disclosure. The embodiment of FIG. 4 is for illustration only. Other embodiments could be used without departing from the scope of this disclosure.

The network 401 initiates the procedure 400 to a UE 402 in RRC_CONNECTED state when the network 401 needs (additional) UE radio access capability information. The network 401 can request the UE 402 to provide radio access capability information by sending an UECapabilityEnquiry message 403 after access stratum (AS) security is setup, as shown in FIG. 4. The UE 402 replies with an UECapabilityInformation message 404. In one embodiment, in information element (IE) UE-NR-Capability within the UECapabilityInformation message 404, the UE 402 can provide the UE's capability information on the supported AI/ML related features, including AI/ML use cases and/or use-case-specific operations, types/structures of AI/ML models, and/or types of training/inference, and/or relevant operations for model managements, etc.

In one embodiment, the UE capability of supporting AI/ML use cases can be defined per UE, and/or differently in time division duplexing (TDD) and frequency division duplexing (FDD), and/or differently in frequency range 1 (FR1) and frequency range 2 (FR2). In one example, for each use case, e.g., CSI compression, CSI prediction, beam management, and positioning, a one-bit indication is used to indicate whether the UE supports the AI/ML-based operation for the respective use case:

| | |
|---|---|
| UE-NR-Capability : : = | SEQUENCE { |
| ai-ml-parameters | AI-ML-parameters OPTIONAL |

}

| | | | |
|---|---|---|---|
| AI-ML-parameters : : = | SEQUENCE { | | |
| csiCompression | ENUMERATED | {supported} | OPTIONAL, |
| csiPrediction | ENUMERATED | {supported} | OPTIONAL, |
| beamManagement | ENUMERATED | {supported} | OPTIONAL, |
| positioning | ENUMERATED | {supported} | OPTIONAL |
| } | | | |

In another example, the UE can enumerate the use cases that the UE supports:

| | |
|---|---|
| UE-NR-Capability : : = | SEQUENCE { |
| ai-ml-parameters | AI-ML-parameters OPTIONAL |
| } | |
| AI-ML-parameters : : = | SEQUENCE { |
| useCases | ENUMERATED {csiCompression, |
| csiPrediction, | BM, positioning} OPTIONAL |

}

In one embodiment, the UE capability of supporting AI/ML sub use cases can be defined per UE, and/or different in TDD and FDD, and/or different in FR1 and FR2. In one example for the use case of CSI compression, the UE can indicate the type of AI/ML that the UE supports, e.g., one-sided model and/or two sided model, and/or the type of CSI compression that the UE supports, e.g., spatial-frequency domain CSI compression and/or temporal-spatial-frequency domain CSI compression. In one example for the use case of CSI prediction, the UE can indicate the type of AI/ML-based CSI prediction that the UE supports, e.g., spatial domain CSI prediction and/or temporal domain prediction. In one example for the use case of beam management, the UE can indicate the type of AI/ML-based beam management that the UE supports, e.g., spatial domain beam management and/or temporal domain beam management. In one example for the use case of positioning, the UE can indicate the type of AI/ML-based positioning that the UE supports, e.g., direct AI/ML-based positioning and/or AI/ML-assisted positioning. In another example, the UE can indicate for the supported (sub) use case whether UE-side model and/or NW-side model is supported. In one example, the UE supporting a certain (sub) use case is mandatory or optionally to support one or more of the associated operations for the use case, which can include data collection/delivery, inference pre-processing and post-processing, assistance information report, model generalization, model switch/activation/deactivation, model update, model transfer, model monitoring:

| UE-NR-Capability : : = | SEQUENCE { |
|---|---|
| ai-ml-parameters | AI-ML-parameters OPTIONAL |
| } | |
| AI-ML-parameters : : = | SEQUENCE { |
| csiCompression | ENUMERATED {one-sided, two-sided, |
| spatial, temporal} OPTIONAL, | |
| csiPrediction | ENUMERATED {spatial, temporal} |
| OPTIONAL, | |
| beamManagement | ENUMERATED {spatial, temporal} |
| OPTIONAL, | |
| positioning | ENUMERATED {direct, assisted} |

OPTIONAL
}

In one embodiment, the UE capability of supporting AI/ML model switching/activation/deactivation can be defined per UE, and/or per (sub) use case, and/or different in TDD and FDD, and/or different in FR1 and FR2. In one example, the UE capability of supporting AI/ML model switching/activation/deactivation can be defined as a mandatory or conditional mandatory or optionally capability. In case of being conditional mandatory, the UE supporting one or more AI/ML (sub) use cases is mandatory to support AI/ML model switching/activation/deactivation. The UE indicating the support of switching/activation/deactivation of AI/ML model is capable of switching/activation/deactivation within a set of AI/ML models according to the NW configuration or dynamic indication, where the AI/ML models can be pre-defined and well-trained for various deployment scenarios, channel models, carrier frequencies, or system parameters.

In one embodiment, the UE capability of supporting a configurable AI/ML model can be defined per UE, and/or per (sub) use case, and/or different in TDD and FDD, and/or different in FR1 and FR2. In one example, the UE capability of supporting a configurable AI/ML model can be defined as a mandatory or conditional mandatory or optionally capability. In case of being conditional mandatory, the UE supporting one or more AI/ML (sub) use cases is mandatory to support configurable AI/ML model. The UE indicating the support of a configurable AI/ML model is capable of constructing the AI/ML model according to the NW configuration on the structure of the NN, including NN type, and the number of layers, etc.

In one embodiment, the UE capability indication for the supported AI/ML model/structure can be defined per UE, and/or per (sub) use case, and/or different in TDD and FDD, and/or different in FR1 and FR2. In one example, the UE can indicate the maximum computation complexity (e.g., FLOPS) that the UE supports. In one example, the UE can indicate the NN structure that the UE supports, e.g., CNN, RNN, LSTM, BiLSTM, transformer, inception. In one example, the UE can indicate the maximum number of NN layers that the UE supports, and/or the maximum number of kernels per layer, and/or the maximum number of weights per layer, and/or the maximum number of branches, and/or the maximum number of real/complex valued model parameters.

In one embodiment, the UE capability indication for the supported learning types can be defined per UE, and/or per (sub) use case, and/or different in TDD and FDD, and/or different in FR1 and FR2. In one example, the UE can indicate if the UE supports offline learning, and/or online learning, and/or supervised learning, and/or unsupervised learning, and/or semi-supervised learning, and/or federated learning, and/or reinforcement learning, and/or transfer learning.

In one embodiment, the UE capability of supporting AI/ML model update can be defined per UE, and/or per (sub) use case, and/or different in TDD and FDD, and/or different in FR1 and FR2. In one example, the UE capability of supporting AI/ML model update can be defined as a mandatory or conditional mandatory or optionally capability. In case of being conditional mandatory, the UE supporting one or more AI/ML (sub) use cases is mandatory to support AI/ML model update. The UE indicating the support of AI/ML model update is capable of update/tunning the AI/ML model parameters by re-training with new data sets. In one example, the UE can indicate for which part of the AI/ML model that the UE supports to update, e.g., weights, and/or layers, and/or model structure.

In one embodiment, the UE capability of supporting AI/ML model transfer can be defined per UE, and/or per (sub) use case, and/or different in TDD and FDD, and/or different in FR1 and FR2. In one example, the UE capability of supporting AI/ML model transfer can be defined as a mandatory or conditional mandatory or optionally capability. In case of being conditional mandatory, the UE supporting two-sided AI/ML model for a certain (sub) use case is mandatory to support AI/ML model transfer. The UE indicating the support of AI/ML model transfer is capable of delivery and/or receiving the AI/ML model parameters over the air interface. In one example, the UE can indicate whether the UE supports full model and/or partial model transfer.

In one embodiment, the UE capability of supporting AI/ML model monitoring can be defined per UE, and/or per (sub) use case, and/or different in TDD and FDD, and/or different in FR1 and FR2. In one example, the UE capability of supporting AI/ML model monitoring can be defined as a mandatory or conditional mandatory or optionally capability. In case of being conditional mandatory, the UE supporting one or more AI/ML (sub) use cases is mandatory to support AI/ML model monitoring. The UE can indicate that the UE supports the AI/ML model monitoring operation, e.g., operations to monitor the inference performance of the AI/ML-based use case:

| UE-NR-Capability : : = | SEQUENCE { | |
|---|---|---|
| ai-ml-parameters | AI-ML-parameters OPTIONAL | |
| } | | |
| AI-ML-parameters : : = | SEQUENCE { | |
| modelSwitch | ENUMERATED {supported} | OPTIONAL, |
| modelUpdate | ENUMERATED {supported} | OPTIONAL, |
| modelTransfer | ENUMERATED {supported} | OPTIONAL, |
| modelMonitoring | ENUMERATED {supported} | OPTIONAL, |
| modelConfigurable | ENUMERATED {supported} | OPTIONAL, |
| flops | ENUMERATED {16, 32, 64} | OPTIONAL, |

| | |
|---|---|
| nn-StructureType | ENUMERATED {cnn, rnn, lstm, bi-lstm, |

| | |
|---|---|
| transformer, inception} | OPTIONAL, |

| | |
|---|---|
| learningType | ENUMERATED {online, offline, |

supervised, unsupervised, semi-supervised, federated,

| | |
|---|---|
| reinforcement, transfer} | OPTIONAL, |

}

NW-Centric AI/ML Model Monitoring

In one embodiment, the AI/ML monitoring is NW centric. The NW can monitor the performance of the UE/NW-side AI/ML model based on the UE reported assistance information and/or based on the NW-side statistics that can reflect the performance of the AI/ML model used for a certain use case, e.g., CSI compression, CSI prediction, spatial/temporal beam prediction, and positioning. Based on these metrics, the NW can decide the operations related to the AI/MIL model at the NW/UE side and send necessary control signaling to the UE.

FIG. 5 is a high level flow diagram for UE behavior in NW-centric AI/ML model monitoring within a communications system utilizing AI/ML empowered UE capabilities according to various embodiments of this disclosure. The embodiment of FIG. 5 is for illustration only, and other process(es) could be used. FIG. 5 does not limit the scope of this disclosure to any particular process.

In the UE behavior illustrated in FIG. 5, the UE applies the AI/ML model on a certain use case and performs related operations according to the NW configuration (operation 501), including AI/ML model monitoring configuration. The configuration can be sent in a RRC message, e.g., RRCSetup, RRCReconfiguration. At operation 502, the UE reports assistance information for AI/ML model monitoring, if configured. At operation 503, the UE receives the signaling/configuration from the NW to trigger fallback to legacy operation of the use case or to trigger AI/ML model adaptation including model switch/update/refinement/transfer, and the UE performs accordingly as follows:
Model switch: The UE selects a qualified AI/ML model among well-trained models to be applied at the UE side;
Model refinement: The UE refines the current AI/ML model at the UE side by re-training and/or re-validation using new training/validation data;
Model update: The UE reconstructs/prepares a new AI/ML model to be applied at the UE side;
Model transfer: The UE directly applies the AI/ML model parameters transferred from the NW;
Fallback to legacy operation: UE disables the AI/ML model for the use case and enables the legacy operation (e.g., CSI measurement and report using Type-I and/or Type-II codebook, beam management and report, DL-PRS measurement and report).

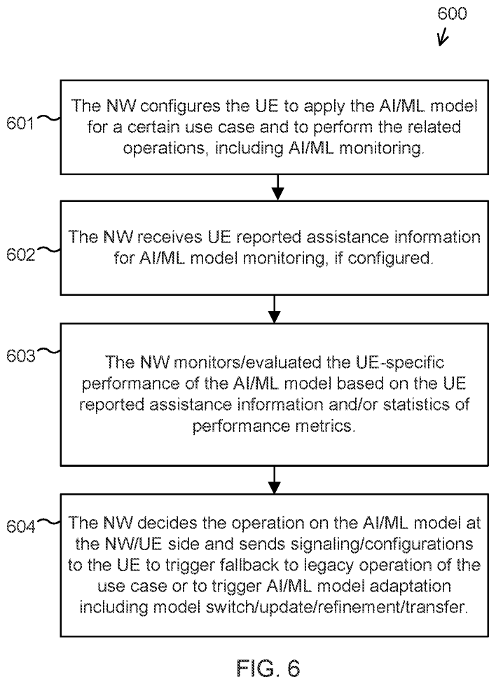

FIG. 6 is a high level flow diagram for NW behavior in NW-centric AI/ML model monitoring within a communications system utilizing AI/ML empowered UE capabilities according to various embodiments of this disclosure. The embodiment of FIG. 6 is for illustration only, and other process(es) could be used. FIG. 6 does not limit the scope of this disclosure to any particular process. The process of FIG. 6 may be performed, for example, at one or more base stations within the NW.

In the NW behavior illustrated in FIG. 6, at operation 601 the NW configures the UE to apply the AI/ML model for a certain use case and to perform the related operations, including AI/ML model monitoring. The configuration can be sent in a RRC message, e.g., RRCSetup, RRCReconfiguration. At operation 602, the NW receives UE reported assistance information for AI/ML model monitoring, if configured. At operation 603, the NW monitors/evaluates the UE-specific performance of the AI/ML model for the use case based on the UE reported assistance information and/or the statistics of performance metrics. At operation 604, the NW decides the operation on the AI/ML model at the NW/UE side and sends signaling/configurations to the UE to trigger fallback to legacy operation of the use case or to trigger AI/ML model adaptation including model switch/update/refinement/transfer.

In one embodiment of NW-centric AI/ML model monitoring, at operation 506, the NW evaluates the performance of the NW-/UE-side AI/ML model based on the NW-side statistics of performance metric, e.g., average user throughput, average UPT, user scheduling latency, PDSCH decoding error rate from HARQ ACK feedback, PUSCH decoding error rate, etc. The NW can also compare the UE-specific performance of the AI/ML model with other UEs and/or with legacy operations, e.g., Type-I/II codebook based CSI report.

In one embodiment of NW-centric AI/ML model monitoring for CSI compression, the NW can configure reciprocal DL RSs and UL RSs for model monitoring. The NW can configure the UE to report assistance information, and evaluates the performance of AI/ML model based on the UE reported assistance information.

For CSI compression, in one example for operation 501/601, the NW can configure the UE to perform model monitoring and/or to report model monitoring assistance information, including AI/ML generated CSI feedback. The model monitoring configuration can include the monitoring RS configuration and/or the assistance information report configuration.
In the monitoring RS configuration, the NW can configure aperiodic/periodic/semi-persistent CSI-RS(s) or SSB(s) as the DL monitoring RS(s), and/or configure aperiodic/periodic/semi-persistent SRS(s) as UL monitoring RS(s). The RS configuration can include one or more fields in IE NZP-CSI-RS-Resource [3], and/or one or more fields of SRS-Resource [3], and/or one or more of the IDs of DL-UL monitoring RS pairs, the IDs of the DL monitoring RS and the IDs of the UL monitoring RS for each pair (e.g., nzp-CSI-ResourceId, srs-ResourceId), the periodicity of the DL-UL pairs, the QCL information of each DL monitoring RS, the spatial relation information of each UL monitoring RS, the resource element mapping of a RS resource in time- and frequency domain, scrambling/sequence ID(s) used to generate the RS(s), the number of ports. In one example, DL-UL monitoring RS pairs can be configured in a way that the ID of a DL monitoring RS resource is associated with the ID of a UL monitoring RS resource. In another example, the DL-UL monitoring RS pairs can be configured in a way that the ID of a DL monitoring RS resource set is associated with the ID of a UL monitoring RS resource set. In one example, the usage of the DL/UL RS resource (set) can be indicated as AI-ML-monitoring explicitly. In another example, periodic/aperiodic/semi-persistent monitoring window can be configured with duration and/or periodicity and/or starting timing offset in SFN/sub-frame/slot/symbol, and the DL/UL RS resource (set) mapping into the monitoring window are implicitly indicated as the monitoring RSs.
In one example, the assistance information can include the CSI feedback report, i.e., the assistance information report configuration includes the AI/ML based CSI report configuration (e.g., CSI-ReportConfig [3]). In one more example, the assistance information can include averaged RS measurement quantities. In this case, the assistance information report configuration can include one or more of the report type (e.g., periodic, semi-persistent, aperiodic), the report periodicity, the report quantities (e.g., averaged values of any of eigenvectors, amplitude coefficients, phase coefficients, CQI, RI, SLI, LI, CRI, SSBRI, RSRP, SINR), the quantization level, the overhead restriction (e.g., the maximum number of bits for the CSI measurement report), and the group-based report enabling/disabling.

For CSI compression, in one example of operation 501, according to the monitoring RS configuration, the UE sends the UL monitoring RS(s) for the NW to measure the CSI, measures the DL monitoring RS(s) that is reciprocal to the indicated UL monitoring RS(s), and generates CSI feedback via the AI/ML model. The UE can report the AI/ML generated CSI feedback according to the AI/ML-based CSI report configuration.

For CSI compression, in one example for operation 502/602, if configured to report assistance information, the UE can report assistance information in PUCCH, and/or PUSCH, and/or in RRC messages (e.g., MeasurementReport and/or UEAssistanceInformation), according to the predefined procedure and/or the assistance information report configuration received at operation 402. In one example, if configured to report CSI feedback report for DL monitoring RS(s) measurement, the UE reports CSI feedback via PUCCH and/or PUSCH. In another example, if configured to report other assistance information than CSI feedback report, the UE reports assistance information in monitoring report in RRC messages (e.g., MeasurementReport and/or UEAssistanceInformation). In the monitoring report, the UE can provides the physical cell ID for which the reporting is being performed, and/or the ID(s) of the measured RS(s), and/or the configured report quantities.

For CSI compression, in one example for operation 603, the NW evaluates the performance of the AI/ML model based on the measurement of the UL monitoring RS(s), which provides the true CSI, and the reported CSI feedback for the DL monitoring RS(s), which provides the estimated CSI.

In another embodiment of NW-centric AI/ML model monitoring for a use case (e.g., CSI compression, CSI prediction, spatial beam prediction, temporal beam prediction, positioning), at operation 501/601, the NW can configure the UE to measure the DL monitoring RSs, and configure the UE to report assistance information, including performance evaluation results and/or CSI feedback and/or UE GNSS position; at operation 603, the NW can evaluates the performance of AI/ML model and determines the operation on the AI/ML model based on the UE reported assistance information.

In one example for operation 501/601, the model monitoring configuration can include the target value of KPIs, the parameters related to monitoring window, and/or the DL monitoring RSs (e.g., CSI-RS, SSB, DL-PRS), and/or the configuration for using legacy operations (e.g., CSI measurement and report using Type-I and/or Type-II codebook, beam management and report, DL-PRS measurement and report), and/or the assistance information report configuration:
The KPIs can include one or more of SGCS, GCS, overhead size (e.g., the number of bits), RSRP, RSRQ, SINR, L1-RSRP, L1-SINR, RI, CQI, SLI, offsets in amplitude/phase coefficients, horizontal positioning accuracy in meters.
The parameters related to monitoring window can include the duration, and/or periodicity, and/or offset in terms of SFN (system frame number)/slot/symbol.
The monitoring RS configuration can include CSI-RS (set) configuration (e.g., IE NZP-CSI-RS-Resource [3]), and/or DL-PRS (set) configuration (e.g., LE NR-DL-PRS-Resource [6]), and/or one or more of the followings: the IDs of the DL monitoring RS (e.g., nzp-CSI-ResourceId), the QCL information of each DL monitoring RS, the resource element mapping of a RS resource in time- and frequency domain, scrambling ID(s) used to generate the RS(s).
For the DL monitoring RSs (e.g., CSI-RS, SSB), the NW can configure the CSI measurement and report using Type-I and/or Type-II codebook [5], and enable/disable codebook-based CSI feedback report for the configured monitoring RSs.
The assistance information report configuration can include one or more fields in LE ReportConfigNR [3] and/or one or more of the followings: the report type (e.g., periodic, event-triggered), the report interval indicating the interval between reports, the report amount indicating the number of reports, the report quantities, the triggering events, the maximum number of RS(s) to report, the number of RS(s) for consolidation/averaging/evaluation, and enabling/disabling CSI feedback report for monitoring RS(s) measurement.
   The report quantities can include the AI/ML-based quantities and/or codebook-based quantities if codebook-based CSI measurement and report is configured. Each set of quantities can include RS-specific and/or average values of KPIs, and/or RS-specific and/or average offsets to the target values of KPIs. The report quantities can also include UE GNSS position.
   For event-triggered reporting, triggering events can be defined in a way that each trigger event consists of one or more conditions and related parameters. In one example, a condition for a trigger event can be defined that the measured RS-specific/average value of a KPI is smaller or greater than the target value by an offset or goes out of the target value range, where the target value(s) and the offset are indicated in the report configuration associated to the trigger event. In another example, a condition for a trigger event can be defined that the measured RS-specific/average value of a KPI is smaller or greater than that value evaluated on the legacy operation by an offset.

In one example of operation 501, the UE applies the monitoring configuration if configured to evaluate the performance of the AI/ML model for a certain use case (e.g., CSI compression, CSI prediction, spatial/temporal beam prediction, positioning). If configured with monitoring window, the UE can consider all DL RS(s) configured during the monitoring window as monitoring RS(s), and measure the DL RS(s). If configured with specific DL monitoring RS(s), the UE can measure the configured DL monitoring RS(s). Based on the measurement of the monitoring RS(s), the UE can generate measurement results, e.g., CSI feedback via the AI/ML model and/or via Type-I/II codebook, and evaluate the RS-specific and/or average performance.

In one example of operation 501, the UE evaluates the KPIs for CSI compression. For two-sided AI/ML model for CSI compression, the AI/ML CSI encoder is deployed at the UE side and the AI/ML CSI decoder is deployed at the NW side. In one way to evaluate the performance of the AI/ML model, for the UE who also has a reference model of the AI/ML CSI decoder, the UE can generate the estimated eigenvectors by the reference CSI decoder, and calculate the overhead size of the AI/ML-based CSI report and/or the SGCS/GCS using the estimated eigenvectors by the reference CSI decoder and the true eigenvectors measured on the DL monitoring RS(s). If configured with the CSI measurement and report using Type-I and/or Type-II codebook, the UE can perform both the AI/ML CSI feedback generation and the Type-I and/or Type-II codebook based CSI feedback generation, and calculate the overhead size of codebook-based CSI report and/or the SGCS/GCS using the codebook-generated estimate eigenvectors and the true eigenvectors measured on the DL monitoring RS(s).

In one example of operation 501, to evaluate the AI/ML model performance on CSI prediction, the UE can measure the DL monitoring RSs at future SFN/slots/symbols for which the CSI is predicted by the UE, generate CSI feedback if configured to report. Based on the measurement of DL monitoring RSs, the UE evaluates the KPIs for CSI prediction. The UE can calculate SGCS/GCS using the monitoring RS(s) measured eigenvectors and the corresponding predicted eigenvectors. The UE can compare the monitoring RS(s) measured values of RSRP/RSRQ/SINR/RI/CQI/SLI/amplitude coefficients/phase/coefficients with the corresponding predicted values.

In one example of operation 501, to evaluate the AI/ML model performance on spatial/temporal beam prediction, the UE can measure the L1-RSRP and/or L1-SINR for the monitoring RSs. Based on the measurement, the UE evaluates the KPIs by comparing the measured values of L1-RSRP and/or L1-SINR with the predicted values. In one example, the UE can select the best N beams with N highest L1-RSRP/L1-SINR from all measured beams, compare to the N predicted values, and evaluate the offsets and/or prediction accuracy. In one more example, the UE can also evaluate the performance in overhead size, e.g., comparing the estimated overhead size of legacy beam measurement report for the monitoring RS(s) and the estimated overhead size of AI/ML-based beam prediction.

In one example for operation 502/602, if configured to report assistance information, the UE can report the assistance information, including CSI feedback and/or KPI evaluation results. The UE sends assistance information reports periodically, aperiodically when requested by the network, or upon any triggering event is fulfilled according to the assistance information report configuration received at operation 402. The UE sends the assistance information report in PUCCH, and/or PUSCH, and/or in RRC messages (e.g., MeasurementReport and/or UEAssistanceInformation), according to the predefined procedure. In one example, if enabled to report CSI feedback report for monitoring RS(s) measurement, the UE reports CSI feedback via PUCCH and/or PUSCH. In another example, the UE reports KPI evaluation results in RRC messages (e.g., MeasurementReport and/or UEAssistanceInformation). In the assistance information report, the UE can provide the physical cell ID for which the reporting is being performed, and/or the ID(s) of the measured RS(s), and/or the configured report quantities. If configured to report average quantities, the UE averages the KPIs over multiple RS(s), where the number of RS(s) for result consolidation/averaging/evaluation is configured. In an example for CSI compression by using two-sided AI/ML model, if the UE uses a reference CSI decoder to evaluate the performance of the AI/ML model, the UE can report to the NW which reference CSI decoder is used in the evaluation. For example, the UE can indicate in the report the ID of the reference CSI decoder and/or parameters that characterize the reference CSI decoder and/or other model description. If configured with the CSI measurement and report using Type-I and/or Type-II codebook, and if enabled to report codebook-based CSI feedback for the monitoring RS(s), the UE can report the codebook-based CSI feedback according to the CSI measurement and report configuration as the legacy operation.

In one example for operation 603, the NW further evaluates the performance of the AI/ML model based on the UE reported assistance information including the UE-side evaluation results and/or CSI feedback.

For operation 503/604, in an example of fallback to legacy operation for the use case (e.g., CSI compression, CSI prediction, spatial/temporal beam prediction, positioning), the NW can disable AI/ML model in a RRC message, e.g., RRCReconfiguration, and include configurations for the legacy operation. Alternatively, the NW can indicate AI/ML model disabling using a MAC CE with subheader containing LCID or eLCID, or using a new bit or a repurposed bit in DCI.

For operation 503/604, as an example of AI/ML model switch, in the case that the AI/ML models are well-trained and associated IDs are pre-defined or pre-configured, the ID of the AI/ML model to switch to can be indicated in a RRC message, e.g., RRCReconfiguration, and/or in a MAC CE with subheader containing LCID or eLCID, and/or using new bits or repurposed bits in DCI.

In one another example of AI/ML model switch/update at operation 503/604, the NW can send parameters that characterize the model to switch/update to in a RRC message, e.g., RRCReconfiguration:
The parameters that characterize the model can include one or more of the followings: the type of NN, the type/number of NN layers, the number of NN weights, the type/number of kernels, the complexity in terms of FLOPs, the type of learning, the type of loss functions, and the KPIs in training/validation. The KPIs for CSI feedback enhancement can be any among SGCS, GCS, overhead size, RSRP, RSRQ, SINR, RI, and CQI. The KPIs for positioning can be the horizontal position accuracy in meters. The KPIs for beam management can be one or more of RSRP, RSRQ, SINR, L1-RSRP, L1-SINR of the selected beam, and/or average beam failure ratio.
The parameters to characterize the model to switch/update can also refer to one or more of deployment scenarios (e.g., UMa, UMi, InH, RMa), carrier frequencies, ISDs, antenna parameters, UE speeds, and other system parameters to which the AI/ML model is applicable.
   Based on the indicated parameters that characterize an AI/ML model, the UE can perform AI/ML model switch/update according to the pre-defined procedure, or according to the explicit switch/update indication sent together with the characterizing parameters, or up to UE implementation.

In one more example of model transfer at operation 503/604, the NW can transfer parameters via a RRC message, e.g., RRCReconfiguration, to be directly applied on the AI/ML model at the UE side. The parameters can include the type/dimension of input/output data, the pre-/post-processing of input/output data, the type of NN, the number of layers, each layer's structure and weights, activation functions, the number of kernels, each kernel's structure and weights, etc.

UE-Centric AI/ML Model Monitoring

For UE-centric AI/ML model monitoring, the UE monitors and evaluates the performance of AI/ML model for a certain use case (e.g., CSI compression, CSI prediction, spatial/temporal beam prediction, positioning) according to the parameters/configurations indicated by the NW, autonomously decides to fallback to legacy operation or to perform model switch/update/transfer/refinement, and informs the NW the UE behavior if necessary.

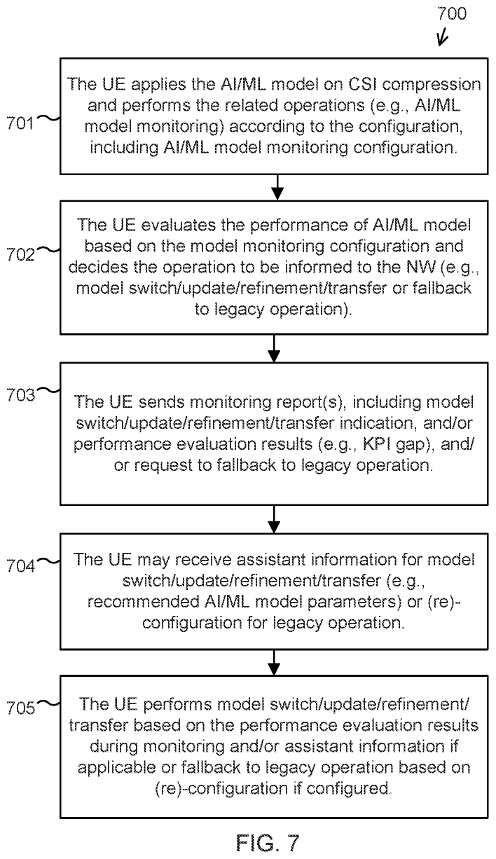

FIG. 7 is a high level flow diagram for UE behavior in UE-centric AI/ML model monitoring within a communications system utilizing AI/ML empowered UE capabilities according to various embodiments of this disclosure. The embodiment of FIG. 7 is for illustration only, and other process(es) could be used. FIG. 7 does not limit the scope of this disclosure to any particular process.

In the UE behavior illustrated in FIG. 7, at operation 701 the UE applies the AI/ML model on a certain use case and performs the related operations (e.g., AI/ML model monitoring) according to the NW configuration, including model monitoring configuration. At operation 702, the UE evaluates the performance of AI/ML model based on the model monitoring configuration and decides the operation to be informed to the NW (e.g., model switch/update/refinement/transfer or fallback to legacy operation). At operation 703, the UE sends monitoring report(s), including model switch/update/refinement/transfer indication, and/or performance evaluation results (e.g., KPI gap), and/or request to fallback to legacy operation. At operation 704, the UE may receive assistant information for model switch/update/refinement/transfer (e.g., recommended AI/ML model parameters) or (re)-configuration for legacy operation. At operation 705, the UE performs model switch/update/refinement/transfer based on the performance evaluation results during monitoring and/or assistant information if applicable or fallback to legacy operation based on (re)-configuration if configured.

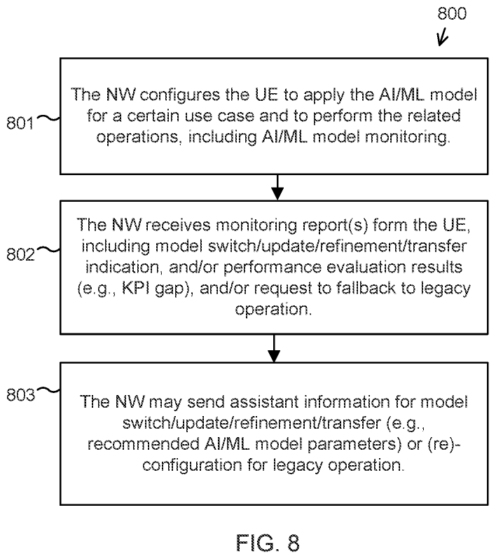

FIG. 8 is a high level flow diagram for NW behavior in UE-centric AI/ML model monitoring within a communications system utilizing AI/ML empowered UE capabilities according to various embodiments of this disclosure. The embodiment of FIG. 8 is for illustration only, and other process(es) could be used. FIG. 8 does not limit the scope of this disclosure to any particular process. The process of FIG. 8 may be performed, for example, at one or more base stations within the NW.

In the NW behavior illustrated in FIG. 8, at operation 801 the NW configures the UE to apply the AI/ML model for a certain use case and to perform the related operations, including AI/ML model monitoring. At operation 802, the NW receives monitoring report(s) form the UE, including model switch/update/refinement/transfer indication, and/or performance evaluation results (e.g., KPI gap), and/or request to fallback to legacy operation. At operation 803, the NW may send assistant information for model switch/update/refinement/transfer (e.g., recommended AI/ML model parameters) if model switch/update/refinement/transfer indication is received in the monitoring report, or the NW sends (re)-configuration for legacy operation if the request of fallback to legacy operation is received in the monitoring report.

For the UE-centric AI/ML model monitoring for a use case (e.g., CSI compression, CSI prediction, spatial beam prediction, temporal beam prediction), in one example for operation 701/801, the model monitoring configuration can include the target value of KPIs, and/or the parameters related to monitoring window, and/or the DL monitoring RSs (e.g., CSI-RS, SSB), and/or the configuration for using legacy operations (e.g., CSI measurement and report using Type-I and/or Type-II codebook, beam management and report), and/or the monitoring report configuration, and/or model management/adaptation configuration.
The KPIs can include one or more of SGCS, GCS, overhead size (e.g., the number of bits), RSRP, RSRQ, SINR, L1-RSRP, L1-SINR, RI, CQI, SLI, offsets in amplitude/phase coefficients.
The parameters related to monitoring window can include the duration, and/or periodicity, and/or offset in terms of SFN (system frame number)/slot/symbol.
The monitoring RS configuration can include CSI-RS (set) configuration (e.g., IE NZP-CSI-RS-Resource [3]), and/or one or more of the followings: the IDs of the DL monitoring RS (e.g., nzp-CSI-ResourceId), the QCL information of each DL monitoring RS, the resource element mapping of a RS resource in time- and frequency domain, scrambling ID(s) used to generate the RS(s).
For the DL monitoring RSs (e.g., CSI-RS, SSB), the NW can configure the CSI measurement and report using Type-I and/or Type-II codebook [5], and enable/disable codebook-based CSI feedback report for the configured monitoring RSs.
The monitoring report configuration can include one or more fields in IE ReportConfigNR [3] and/or one or more of the followings: report type (e.g., periodic, conditional event-triggered), the report interval indicating the interval between reports, the report amount indicating the number of reports, the report quantities, the conditional events, the maximum number of RS(s) to report, the number of RS(s) for consolidation/averaging/evaluation, enabling/disabling CSI feedback report for monitoring RS(s) measurement.
   The report quantities can include the AI/ML-based quantities and/or codebook-based quantities if codebook-based CSI measurement and report is configured. Each set of quantities can include RS-specific and/or average values of KPIs, and/or RS-specific and/or average offsets to the target values of KPIs.
   For conditional event-triggered reporting or for conditional event-triggered AI/ML model management/adaptation, conditional events can be defined in a way that each event consists of one or more conditions, related parameters, and the associated operations to be informed to the NW upon the event condition(s) is (are) fulfilled. In one example, a condition for an event can be defined that the measured RS-specific/average value of a KPI is smaller or greater than the target KPI value by an offset or goes out of the KPI value range. In another example, a condition for an event can be defined that the measured RS-specific/average value of a KPI is smaller than the value evaluated on the legacy operation by an offset. The target value and/or the offset are indicated in the report configuration associated to the event.
   In one example, the associated operation to be informed to the NW upon each periodical monitoring report or upon the any conditional event is fulfilled is one of the following:
      Model switch: UE selects a qualified AI/ML model among well-trained models to be applied at the UE side;
      Model refinement: UE refines the current AI/ML model at the UE side by re-training and/or re-validation using new training/validation data;
      Model update: UE reconstructs/prepares a new AI/ML model to be applied at the UE side;
      Model transfer: UE request NW to transfer AI/ML model parameters to be directly applied at the UE side;
      Fallback to legacy operation: UE requests to disable the AI/ML model for the use case and enable the legacy operation (e.g., CSI measurement and report using Type-I and/or Type-II codebook, beam management and report).

In one example at operation 701, if configured with monitoring window, the UE can consider all DL RS(s) configured during the monitoring window as monitoring RS(s), and measure the DL RS(s). If configured with specific DL monitoring RS(s), the UE can measure the configured DL monitoring RS(s). Based on the measurement of the monitoring RS(s), the UE can generate measurement results, e.g., CSI feedback via the AI/UL model and/or via Type-I/II codebook, and evaluate the RS-specific and/or average performance.

In one example for operation 702, the UE evaluates the KPIs for CSI compression. For two-sided AI/ML model for CSI compression, the AI/ML CSI encoder is deployed at the UE side and the AI/ML CSI decoder is deployed at the NW side. In one way to evaluate the performance of the AI/ML model, for the UE who also has a reference model of the AI/ML CSI decoder, the UE can generate the estimated eigenvectors by the reference CSI decoder, and calculate the overhead size of the AI/ML-based CSI report and/or the SGCS/GCS using the estimated eigenvectors by the reference CSI decoder and the true eigenvectors measured on the DL monitoring RS(s). If configured with the CSI measurement and report using Type-I and/or Type-II codebook, the UE can perform both the AI/ML CSI feedback generation and the Type-I and/or Type-II codebook based CSI feedback generation, and calculate the overhead size of codebook-based CSI report and/or the SGCS/GCS using the codebook-generated estimate eigenvectors and the true eigenvectors measured on the DL monitoring RS(s).

In one example of operation 702, to evaluate the AI/ML model performance on CSI prediction, the UE can measure the DL monitoring RSs at future SFN/slots/symbols for which the CSI is predicted by the UE, generate CSI feedback if configured to report. Based on the measurement of DL monitoring RSs, the UE evaluates the KPIs for CSI prediction. The UE can calculate SGCS/GCS using the monitoring RS(s) measured eigenvectors and the corresponding predicted eigenvectors. The UE can compare the monitoring RS(s) measured values of RSRP/RSRQ/SINR/RI/CQI/SLI/amplitude coefficients/phase/coefficients with the corresponding predicted values.

In one example of operation 702, to evaluate the AI/ML model performance on spatial/temporal beam prediction, the UE can measure the L1-RSRP and/or L1-SINR for the monitoring RSs. Based on the measurement, the UE evaluates the KPIs by comparing the measured values of L1-RSRP and/or L1-SINR with the predicted values. In one example, the UE can select the best N beams with N highest L1-RSRP/L1-SINR from all measured beams, compare to the N predicted values, and evaluate the offsets and/or prediction accuracy. In one more example, the UE can also evaluate the performance in overhead size, e.g., comparing the estimated overhead size of legacy beam measurement report for the monitoring RS(s) and the estimated overhead size of AI/ML-based beam prediction.

In one example for operation 702, the UE can compare the evaluated KPI values of the AI/ML model with the configured target KPI values, and/or compare the evaluated KPI values of the AI/ML model with the evaluated KPI values of the legacy operation (e.g., CSI measurement and report using Type-I and/or Type-II codebook, beam management and report). In one example, the UE decides the operation to be informed to the NW upon each periodical monitoring report based on the comparison. In another example, if conditional events are configured, the UE informs the associated operation defined for the conditional event upon any conditional event is fulfilled.

In one example for operation 703/802, the UE sends monitoring reports periodically or upon any conditional event is fulfilled according to the monitoring report configuration received at operation 701. The UE sends the monitoring report in PUCCH, and/or PUSCH, and/or in RRC messages (e.g., MeasurementReport and/or UEAssistanceInformation), according to the predefined procedure. In one example, if enabled to report CSI feedback report for monitoring RS(s) measurement, the UE reports CSI feedback via PUCCH and/or PUSCH. In another example, the UE reports KPI evaluation results in RRC messages (e.g., MeasurementReport and/or UEAssistanceInformation). In the monitoring report, the UE can provide the physical cell ID for which the reporting is being performed, and/or the operation to be informed to the NW (i.e., model switch/update/refinement/transfer or fallback to legacy), and/or the ID(s) of the measured RS(s), and/or the configured report quantities. If configured with the CSI measurement and report using Type-I and/or Type-II codebook, and if enabled to report codebook-based CSI feedback for the monitoring RS(s), the UE can report the codebook-based CSI feedback according to the CSI measurement and report configuration.

For operation 704/803, in an example of fallback to legacy operation for the use case (e.g., CSI compression, CSI prediction, spatial/temporal beam prediction, position), the NW can indicate AI/ML model disabling in a RRC message, e.g., RRCReconfiguration, and include CSI measurement and report configurations for the legacy operation. Alternatively, the NW can indicate AI/ML model disabling using a MAC CE with subheader containing LCID or eLCID, or using a new bit or a repurposed bit in DCI.

For operation 704/803, as an example of NW providing assistance information for AI/ML model switch, in the case that the AI/ML models are well-trained and associated IDs are pre-defined or pre-configured, the ID of the AI/ML model to switch to can be indicated in a RRC message, e.g. RRCReconfiguration, and/or in a MAC CE with subheader containing LCID or eLCID, and/or using new bits or repurposed bits in DCI.

In one another example of NW providing assistance information for AI/ML model switch/update at operation 704/803, the NW can provide parameters that characterizes the model to switch/update in a RRC message, e.g., RRCReconfiguration:
The parameters that characterize the model can include one or more of the followings: the type of NN, the type/number of NN layers, the number of NN weights, the type/number of kernels, the complexity in terms of FLOPs, the type of learning, the type of loss functions, and the performance target in training/validation. The performance target for CSI feedback enhancement can be one or more values of SGCS, GCS, overhead size, RSRP, RSRQ, SINR, RI, CQI. The performance target for positioning can be the horizontal position accuracy in meters. The performance target for beam management can be one or more values of RSRP, RSRQ, SINR of the selected beam, and/or average beam failure ratio.
The parameters to characterize the model to switch/update to can also refer to one or more of deployment scenarios (e.g., UMa, UMi, InH, RMa), carrier frequencies, ISDs, antenna parameters, UE speeds, and other system parameters to which the AI/ML model is applicable.

In one more example of model transfer at operation 704/803, the NW can provide assistance information via a RRC message, e.g., RRCReconfiguration, which includes parameters to be directly applied on the AI/ML model at the UE side. The parameters can include the type/dimension of input/output data, the pre-/post-processing of input/output data, the type of NN, the number of layers, each layer's structure and weights, activation functions, the number of kernels, each kernel's structure and weights, etc.

In one example for operation 705, if the UE does not receive assistance information from the NW for model switch/update/refinement/transfer at operation 704, the UE can perform model switch/update/refinement alone, for example, based on the AI/ML performance evaluation results during monitoring and/or up to UE implementation. In another example for operation 705, if the UE receives assistant information from the NW for model switch/update/refinement/transfer at operation 704, the UE can choose to use the assistance information if applicable to perform model switch/update/refinement/transfer, and/or to perform model switch/update/refinement/transfer based on the AI/ML performance evaluation results during monitoring, and/or fallback to legacy operation based on (re)-configuration if configured. In one more example for operation 705, if conditional event triggered AI/ML model management and adaption is configured, and if a conditional event is fulfilled according to the AI/ML performance evaluation based on model monitoring results, UE performs the action of AI/ML model management/adaption that is associated to the fulfilled conditional event.

For illustrative purposes the steps of algorithms above are described serially. However, some of these steps may be performed in parallel to each other. The operation diagrams illustrate example methods that can be implemented in accordance with the principles of the present disclosure and various changes could be made to the methods illustrated in the flowcharts. For example, while shown as a series of steps, various steps in each figure could overlap, occur in parallel, occur in a different order, or occur multiple times. In another example, steps may be omitted or replaced by other steps.

Although this disclosure has been described with an exemplary embodiment, various changes and modifications may be suggested to one skilled in the art. It is intended that this disclosure encompass such changes and modifications as fall within the scope of the appended claims.

What is claimed is:

1. A method, comprising:
performing, at a user equipment (UE), an artificial intelligence/machine learning (AI/ML) monitoring operation based on a received monitoring configuration forming part of a configuration of use of an AI/ML model for an operation;
reporting, based on the monitoring configuration, AI/ML model assistance information including AI/ML model monitoring results from the AI/ML monitoring operation;
receiving, based on the AI/ML model monitoring results, AI/ML model management and adaptation information; and
performing an AI/ML model management and adaptation operation based on the AI/ML model management and adaptation information.

2. The method of claim 1, wherein the AI/ML model management and adaptation information includes:
an indication of an action of AI/ML model management and adaptation; and
parameters that characterize the action of AI/ML model management and adaptation.

3. The method of claim 2, wherein:
when the indication of the action of AI/ML model management and adaptation comprises an indication of model switch, the method further comprises selecting, at the UE, an AI/ML model from among trained models to be applied at the UE,
when the indication of the action of AI/ML model management and adaptation comprises an indication of model refinement or update, the method further comprises refining, at the UE, the AI/ML model by one or both of re-training using new training data, or re-validation using new validation data,
when the indication of the action of AI/ML model management and adaptation comprises an indication of model update, the method further comprises one of reconstructing or preparing, at the UE, a new AI/ML model to be applied at the UE, and
when the indication of the action of AI/ML model management and adaptation comprises an indication of model transfer, the method further comprises applying, at the UE, received AI/L model parameters.

4. The method of claim 1, wherein the monitoring configuration includes:
resources for monitoring in time or frequency or spatial domain, report quantities, and report types for the operation; or
conditions that trigger the UE to one of report AI/ML monitoring results or autonomously perform AI/ML model management and adaptation.

5. The method of claim 1, further comprising one of:
reporting AI/ML monitoring results when a first condition is fulfilled;
requesting, by the UE, AI/ML model management and adaptation information based on the AI/ML model monitoring results, wherein a request for the AI/ML model management and adaptation information specifies an action of AI/ML model management and adaptation for the operation; or
autonomously performing, at the UE, an action of AI/ML model management and adaptation for the operation when a second condition is fulfilled.

6. The method of claim 1, further comprising:
receiving, at the UE, a request for UE capabilities of AI/ML functionality; and
transmitting, by the UE, information of the UE capabilities of AI/ML functionality.

7. The method of claim 6, wherein the UE capabilities of AI/ML functionality comprise:
supported AI/ML-based operations, or
supported types or structures of AI/ML models, or
supported types of training or inferences, or
supported operations for model management and adaptation.

8. A user equipment (UE), comprising:
a transceiver; and
a processor configured to
perform, at the UE, an artificial intelligence/machine learning (AI/ML) monitoring operation based on a received monitoring configuration forming part of a configuration of use of an AI/ML model for an operation, and
report, based on the monitoring configuration, AI/ML model assistance information including AI/ML model monitoring results from the AI/ML monitoring operation,
wherein the transceiver is configured to receive, based on the AI/ML model monitoring results, AI/ML model management and adaptation information, and
wherein the processor is further configured to perform an AI/NIL model management and adaptation operation based on the AI/ML model management and adaptation information.

9. The UE of claim 8, wherein the AI/ML model management and adaptation information includes:
an indication of an action of AI/ML model management and adaptation; and
parameters that characterize the action of AI/ML model management and adaptation.

10. The UE of claim 9, wherein:
when the indication of the action of AI/ML model management and adaptation comprises an indication of model switch, the UE is configured to select an AI/ML model from among trained models to be applied at the UE,
when the indication of the action of AI/ML model management and adaptation comprises an indication of model refinement or update, the UE is configured to refine the AI/ML model by one or both of re-training using new training data, or re-validation using new validation data,
when the indication of the action of AI/ML model management and adaptation comprises an indication of model update, the UE is configured to one of reconstruct or prepare a new AU/ML model to be applied at the UE, and
when the indication of the action of AI/ML model management and adaptation comprises an indication of model transfer, the UE is configured to apply received AI/ML model parameters.

11. The UE of claim 8, wherein the monitoring configuration includes:
resources for monitoring in time or frequency or spatial domain, report quantities, and report types for the operation; or
conditions that trigger the UE to one of report AI/ML monitoring results or autonomously perform AI/ML model management and adaptation.

12. The UE of claim 8, wherein the processor is further configured to one of:
report AI/ML monitoring results when a first condition is fulfilled,
request AI/ML model management and adaptation information based on the AI/ML model monitoring results, wherein a request for the AI/ML model management and adaptation information specifies an action of AI/ML model management and adaptation for the operation or
autonomously perform, at the UE, an action of AI/ML model management and adaptation for the operation when a second condition is fulfilled.

13. The UE of claim 8, wherein the transceiver is further configured to:
receive a request for UE capabilities of AI/ML functionality; and
transmit information of the UE capabilities of AI/ML functionality.

14. The UE of claim 13, wherein the UE capabilities of AI/ML functionality comprise:
supported AI/ML-based operations, or
supported types or structures of AI/ML models, or
supported types of training or inferences, or
supported operations for model management and adaptation.

15. A base station, comprising:
a transceiver configured to:
transmit, from a base station to a user equipment (UE), a monitoring configuration for monitoring an artificial intelligence/machine learning (AI/ML) monitoring operation, the monitoring configuration forming part of a configuration of use of an AI/ML model for an operation, and
receive, from the UE, AI/ML use assistance information including AI/ML model monitoring results from the AI/ML monitoring operation; and
a processor configured to:
evaluate, based on the AI/ML model monitoring results, UE-specific performance of the use of the AI/ML model for the operation, and
determine AI/ML model management and adaptation information corresponding to the AI/ML model monitoring results.

16. The base station of claim 15, wherein the transceiver is further configured to:
transmit, to the UE, an indication of an action of AI/ML model management and adaptation and parameters that characterize the action of AI/ML model management and adaptation.

17. The base station of claim 15, wherein the transceiver is further configured to:
transmit, to the UE, a request for UE capabilities of AI/ML functionality; and
receiving, at the base station from the UE, information of the UE capabilities of AI/ML functionality.

18. The base station of claim 17, wherein the UE capabilities of AI/ML functionality comprise:
supported AI/ML-based operations,
supported types or structures of AI/ML models,
supported types of training or inferences, or
supported operations for model management and adaptation.

19. The base station of claim 15, wherein the AI/ML model management and adaptation information includes an indication of an action of AI/ML model management and adaptation, and
wherein:
when the indication of the action of AI/ML model management and adaptation comprises an indication of model switch, the UE selects an AI/ML model from among trained models to be applied at the UE,
when the indication of the action of AI/ML model management and adaptation comprises an indication of model refinement or update, the UE refines the AI/ML model by one or both of re-training using new training data, or re-validation using new validation data,
when the indication of the action of AI/ML model management and adaptation comprises an indication of model update, the UE one of reconstructs or prepares a new AI/ML model to be applied at the UE, and
when the indication of the action of AI/ML model management and adaptation comprises an indication of model transfer, the UE applies received AI/ML model parameters.

20. The base station of claim 15, wherein the monitoring configuration includes:
resources for monitoring in time or frequency or spatial domain, report quantities, and report types for the operation, or
conditions that trigger the UE to one of report AI/ML monitoring results or autonomously perform AI/ML model management and adaptation.
